(19) United States
(12) Patent Application Publication
(10) Pub. No.: US 2009/0061723 A1
(43) Pub. Date: Mar. 5, 2009

(54) METHOD AND APPARATUS FOR SEALING FLUORESCENT LAMP

(76) Inventors: Young Keun LEE, Uiwang-si (KR); Myong Gi Jang, Yeonsu-gu (KR)

Correspondence Address: KED & ASSOCIATES, LLP, P.O. Box 221200, Chantilly, VA, 20153-1200, US

(21) Appl. No.: 12/132,140

(22) Filed: Jun. 3, 2008

(30) Foreign Application Priority Data
Aug. 31, 2007 (KR) 10-2007-0088205
Aug. 31, 2007 (KR) 10-2007-0088210

(51) Int. Cl. H01J 9/02; H01J 9/46

(52) U.S. Cl. 445/26; 445/66

(57) ABSTRACT

A method for sealing a fluorescent lamp performs a first heating operation to heat a region of a glass tube in which a fluorescent material is coated, stretches the glass tube at the heated region, and performs a second heating operation to heat the stretched region of the glass tube.

### BACKGROUND

1. Field

One or more embodiments relate to lighting devices and their methods of manufacture.

2. Background

A liquid crystal display (LCD) is a non-emissive device that uses a backlight unit (BLU) for clearly providing images on a screen. The light source for the backlight unit may be a fluorescent lamp having a diameter of several millimeters. Examples of fluorescent lamps of this type include cold cathode fluorescent lamps (CCFLs) and external electrode fluorescent lamps (EEFLs).

### BRIEF DESCRIPTION OF THE DRAWINGS

FIGS. 1 and 2 are diagrams showing types of fluorescent lamps.

FIGS. 3 to 5 are diagrams showing cross-sectional views of coating and sealing processes for the lamps in FIGS. 1 and 2.

FIG. 6 is a diagram showing a cross-sectional view of a temporary sealing process performed for the lamps of FIGS. 1 and 2.

FIG. 7 is a diagram showing a cross-sectional view of a state where a fine tube is attached to an end of a glass tube in forming the aforementioned lamp.

FIGS. 8 to 10 are diagrams showing how a lamp may be sealed at its ends.

FIG. 11 is a diagram showing a sealing device for exhausting and sealing a glass tube as mentioned above.

FIGS. 12 to 14 are diagrams showing a seal-cutting apparatus for cutting seals in a tube.

FIG. 15 is a flowchart showing steps included in one embodiment of a method for sealing a fluorescent lamp.

FIG. 16 is a diagram showing a front view of an apparatus for sealing a fluorescent lamp.

FIG. 17 is a diagram showing another embodiment of an apparatus for sealing a fluorescent lamp.

FIGS. 18 and 19 are diagrams showing an auxiliary chuck that may be used with the apparatus shown in FIG. 17.

FIGS. 20 to 25 are diagrams showing the operation of the apparatus shown in FIG. 17.

FIG. 26 is a diagram showing another embodiment of an apparatus for sealing a fluorescent lamp.

FIGS. 27 and 28 are diagrams showing a main part of the apparatus for sealing a fluorescent lamp shown in FIG. 26.

FIGS. 29 to 32 are diagrams showing the operation of the apparatus for sealing a fluorescent lamp shown in FIG. 26.

### DETAILED DESCRIPTION

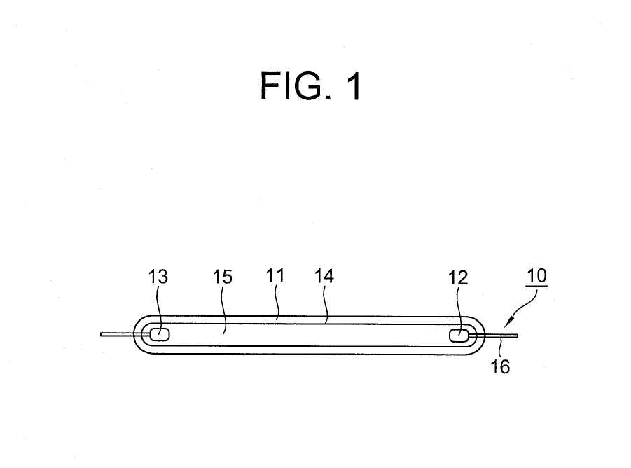

FIG. 1 shows one type of cold cathode fluorescent lamp 10 that includes a long glass tube 11, an anode electrode 12, and a cathode electrode 13. The electrodes are attached to respective ends of the glass tube and leads 16 extend from the ends and are connected to the electrodes, respectively. A fluorescent material 14 is coated on an inner wall of the tube and a mixed gas containing inert gases such as mercury vapor, argon, and neon is filled in an inner space 15 of the tube.

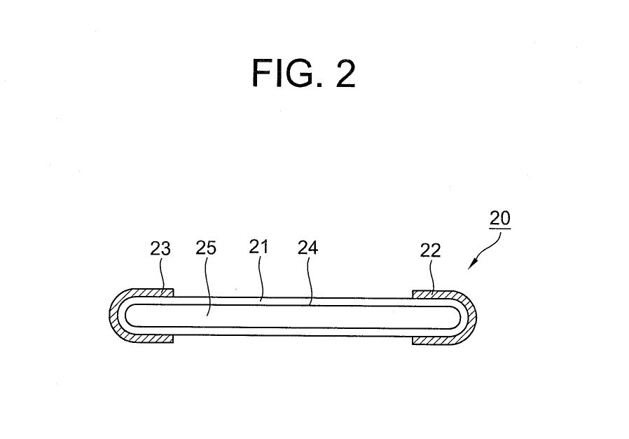

FIG. 2 shows one type of an external electrode fluorescent lamp 20 having a glass tube 21. Both ends of the glass tube are sealed and electrodes 22 and 23 are provided to externally surround the ends. An electric field is formed in the glass tube by the electrodes to cause electricity to be discharged through gas. A fluorescent material 24 is coated on an inner wall of the glass tube, and a mixed gas containing inert gases such as mercury, argon, and neon is filled in an inner space 25 of the tube.

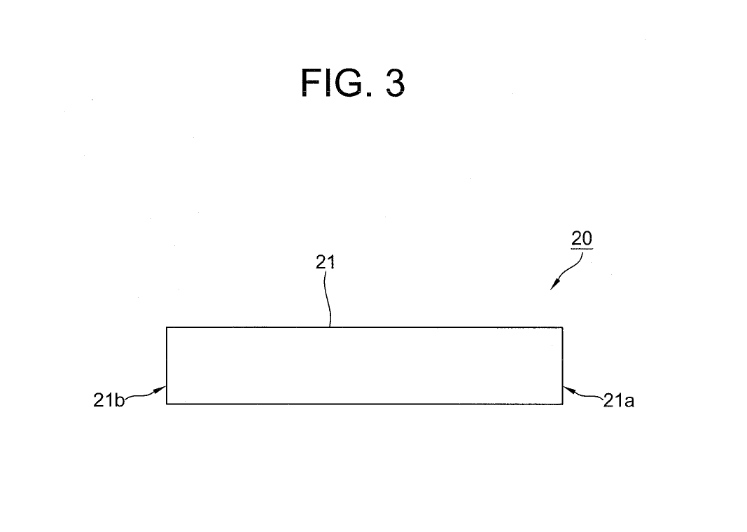

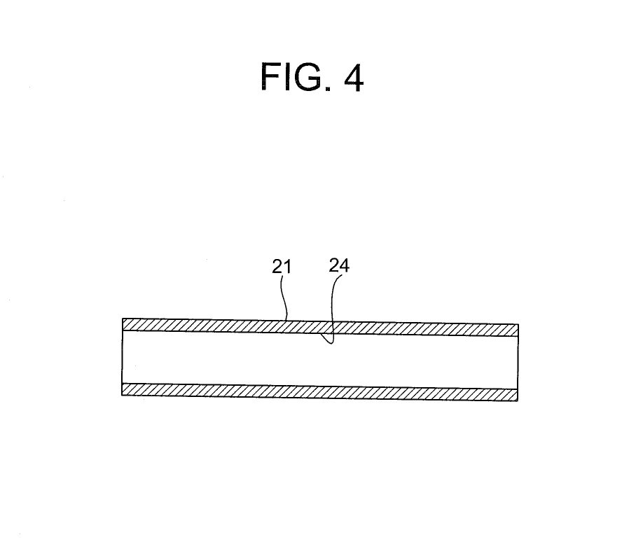

In order to manufacture lamps 10 or 20, different processes are used to coat a fluorescent material onto the inside of the glass tube and to seal ends of the tube once coated. In the coating process, glass tube 21 is prepared as shown in FIG. 3 and a fluorescent material 24 is coated onto the inside of the glass tube as shown in FIG. 4 and then heated for stabilization.

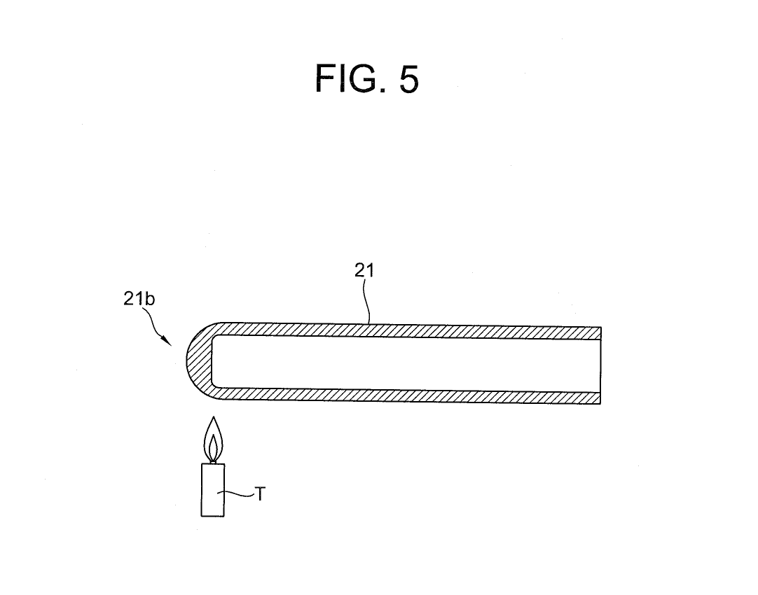

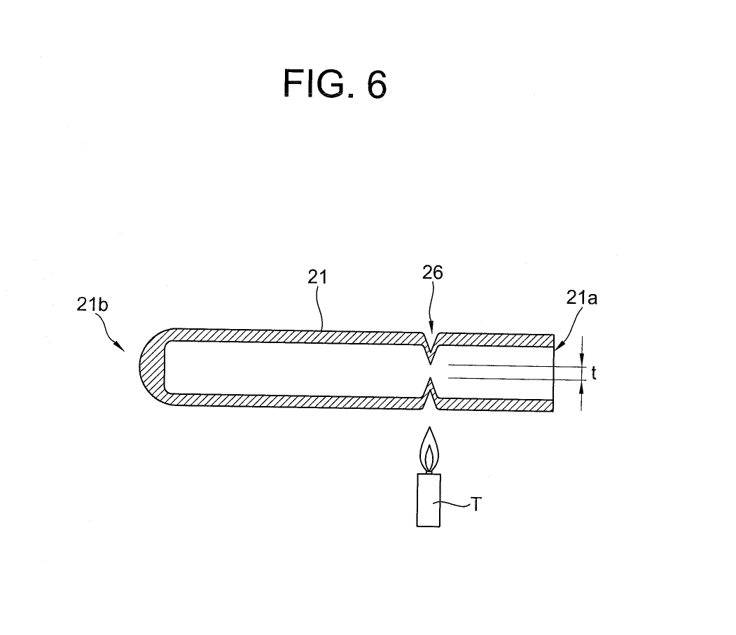

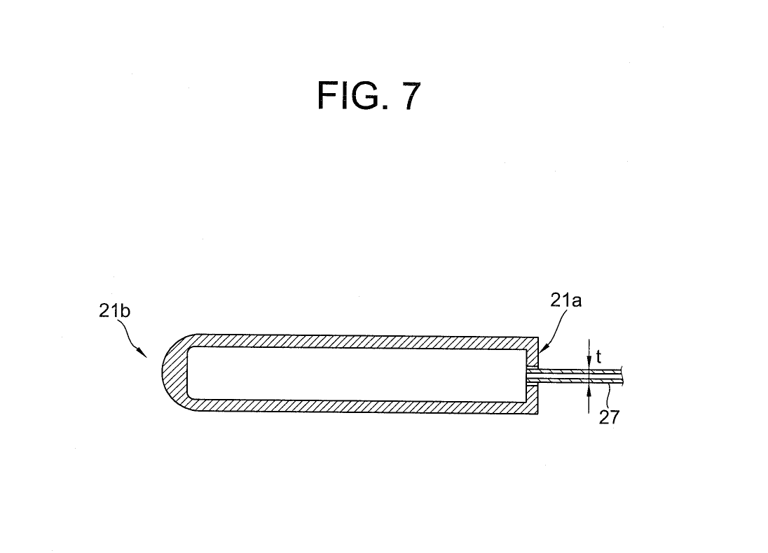

Next, as shown in FIG. 5, the first end 21b of the tube is heated by a torch T to seal the tube while it is rotated. Then, prior to the process of sealing second end 21a of the tube, a preliminary process to seal a “sealing region” by heat from a torch T is performed to form a temporary sealing region 26, while the tube is rotated as shown in FIG. 6. Alternatively, the preliminary process may include attaching a fine tube 27 having a small diameter to second end 21a of the tube as shown in FIG. 7.

The preliminary processes are performed in order to reduce the diameter of the glass tube in advance. This advanced step is performed because the glass tube is fixed to a head connected to an exhaust line or a mercury injection line during the process of sealing the second end, and thus it is impossible to rotate the glass tube under these circumstances. Using a preliminary process, it is possible to seal the second end without rotation. The diameter of the temporary sealing region 26 or the fine tube 27 may be about 4 mm.

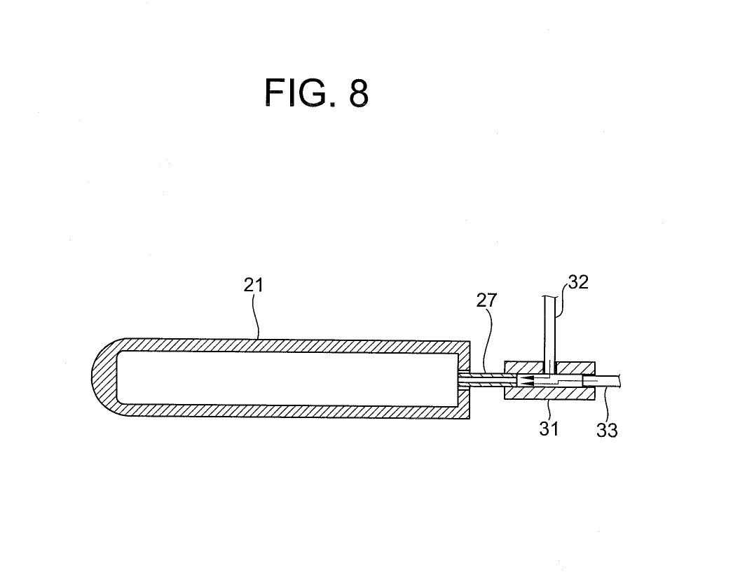

After the preliminary process is completed, a process of sealing the second end of the glass tube is performed as shown in FIG. 7, which will be described in greater detail with reference to FIGS. 8 to 10.

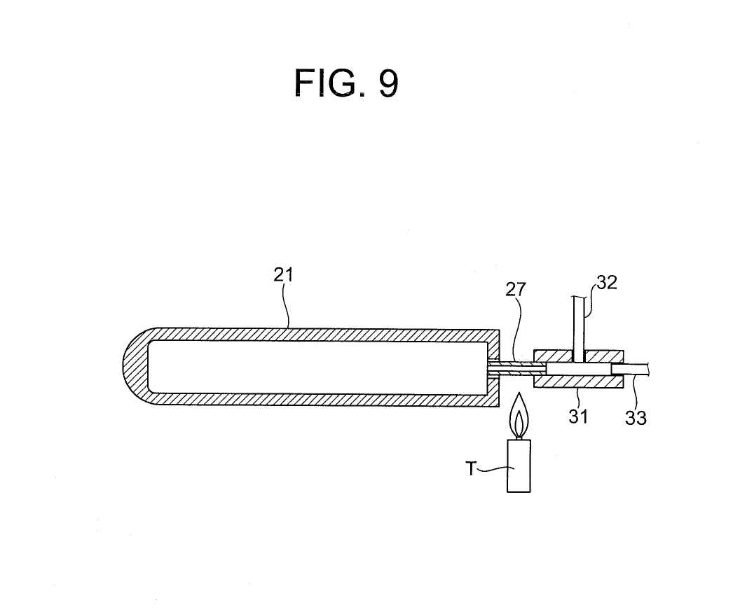

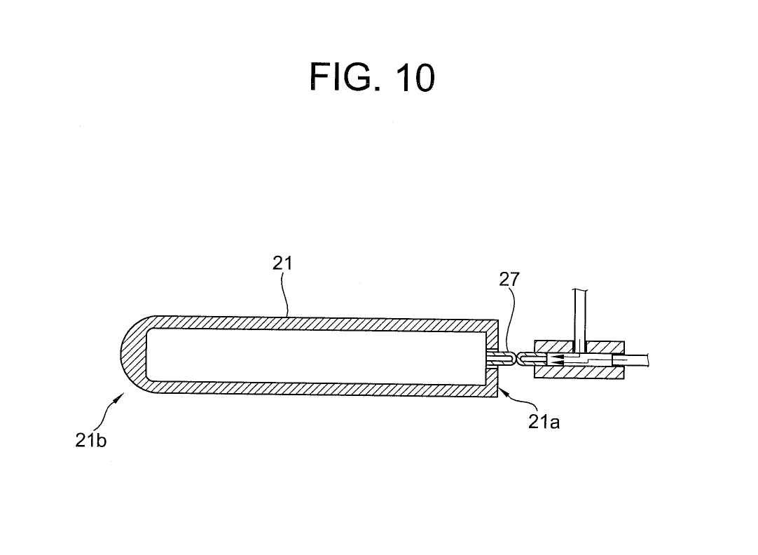

First, as shown in FIG. 8, an end of the fine tube 27 is mounted on a head 31. The head is connected to a line 32 for exhausting air and injecting an inert gas (hereinafter referred to as an “exhaust line”), and a line 33 for injecting liquid mercury (hereinafter referred to as a “mercury injection line”). Prior to injection of the inert gas, a process of injecting a cleaning gas and an exhaust process are repeated several times to clean the inside of the glass tube. After the inert gas and mercury are injected, the end of the fine tube 27 is heated by the torch T to complete the sealing process (See FIGS. 9 and 10).

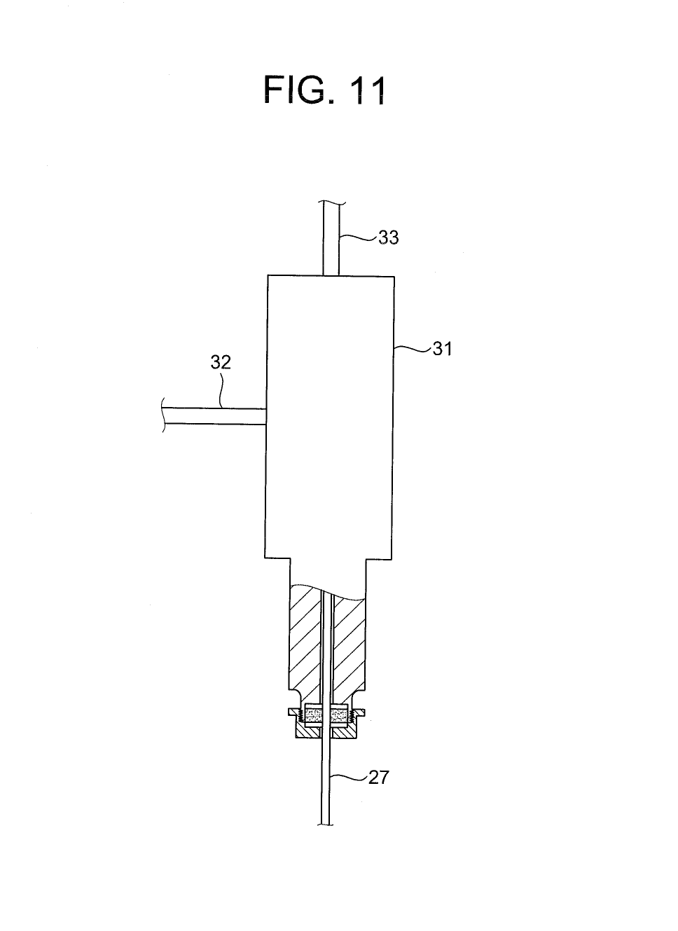

The second end sealing process is performed using an apparatus shown in FIG. 11. As shown in the figure, the apparatus uses head 31 to hold the fine tube 27, the exhaust line 32 and the mercury injection line 33.

The aforementioned process is complicated since the preliminary or fine tube attaching sealing or process is required to be performed before the second end of the glass tube is sealed. The process may also make the tube susceptible to gas leakage or damage, and the quality of the finished product may not be constant, especially since the process of sealing the fine tube is performed manually by a worker. Furthermore, there is a further problem in that it is difficult to quantitatively supply the mercury, since the temporary sealing region or the inner wall of the fine tube may be smeared with liquid mercury when the liquid mercury is injected.

Moreover, although both ends of the glass tube shown in FIG. 10 are sealed, a portion of the fine tube still remains. In order to remove the unnecessary portion and form a desired shape, a seal-cutting process must be performed in a seal-cutting apparatus.

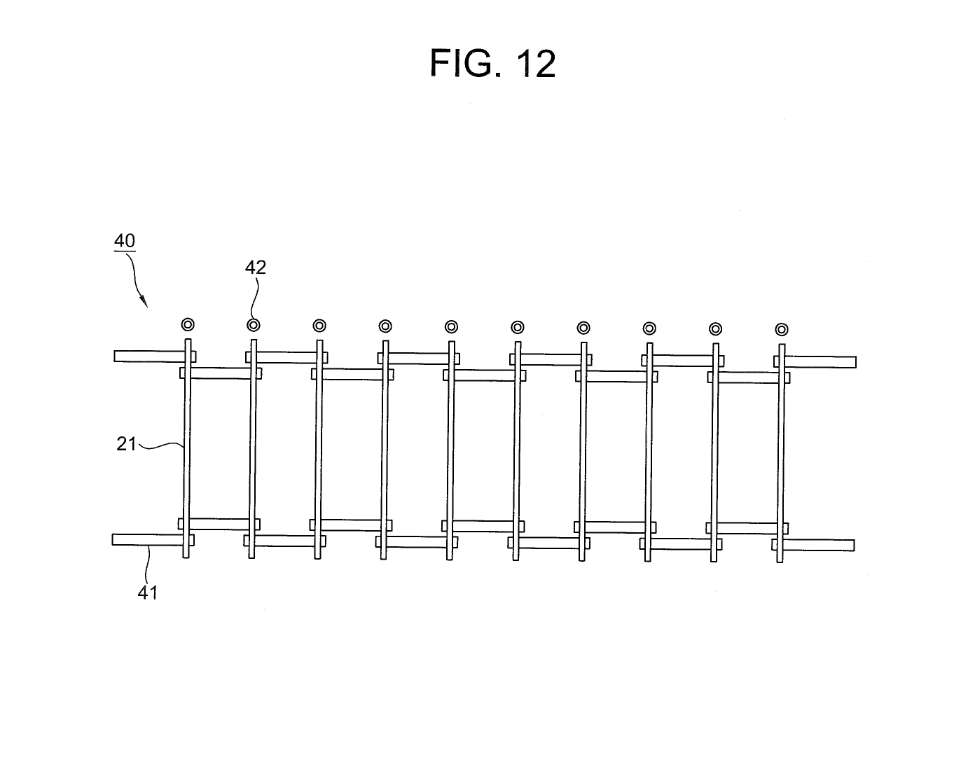

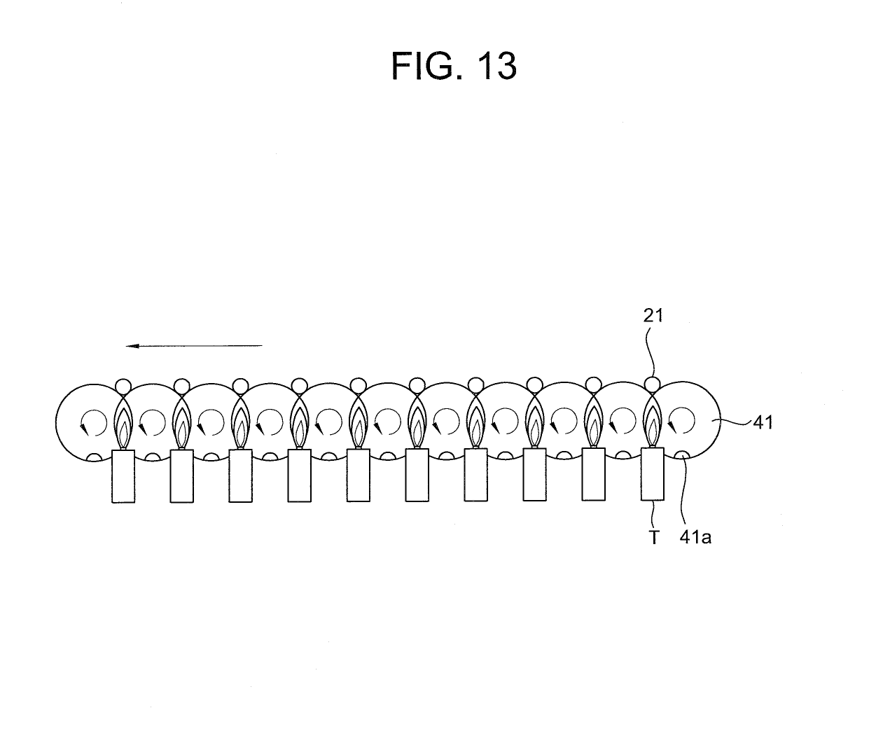

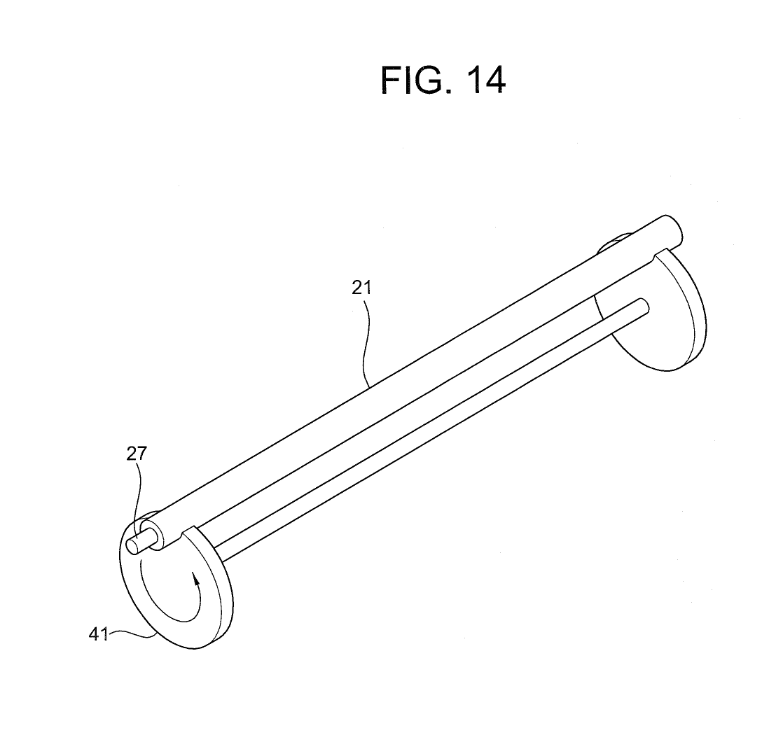

FIGS. 12-14 show one type of seal-cutting apparatus 40. This apparatus includes a plurality of rotating plates 41 arranged to overlap one another in plural rows. Each rotating plate includes a groove 41a for transferring a glass tube 21. When the glass tube is positioned between rotating plates overlapping each other, it is heated by a torch T disposed at the bottom thereof. In this state, when the rotating plates are rotated, the glass tube is received on the groove 41a and transferred to the next part of overlapping plates. Another torch T may also disposed at the bottom of the next part of overlapping plates and to heat the glass tube again. In the above manner, the glass tube is heated about ten times, and the seal-cutting process is completed.

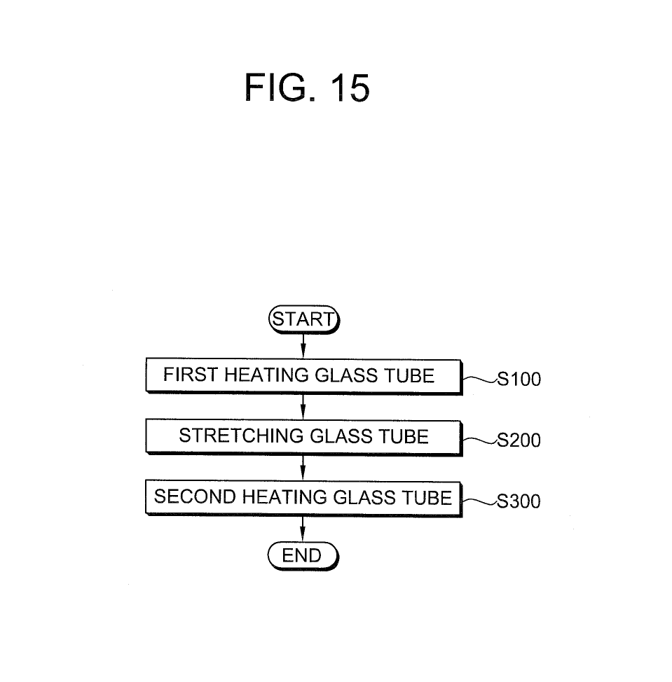

FIG. 15 shows steps included in one embodiment of a method for sealing a fluorescent lamp. In order to seal a fluorescent lamp, first, a glass tube in which a fluorescent material is coated is heated (S100, a first heating step). At this time, the heated region corresponds to an end of the glass tube to be sealed. Moreover, it is preferable that the first heating step (S100) is performed while rotating the glass tube so that the tube may be uniformly heated.

When the glass tube is heated to above a predetermined temperature, the glass melts. At this time, the glass tube is stretched at both sides based on the heated region (S200, a stretching step). When the tube is stretched, the diameter of the heated region becomes smaller. When the glass tube is stretched to an appropriate degree, the diameter thereof may be equal to that of the temporary sealing region 26 described above with reference to FIG. 6 or that of the fine tube 27 described above with reference to FIG. 7. In order to extend the region having the reduced diameter, a step of sufficiently stretching the glass tube while it is heated over a wide range is performed. To accomplish this, although it is possible to increase the area of a heat source for heating the glass tube, a single heat source may be moved in the longitudinal direction of the tube during heating.

When a portion of the thinned glass tube produced by the stretching step (S200) is heated again (S300, a second heating step), the thinned tube is melted to close the tube body, thereby completing the sealing process of the tube. Although the second heating step (S300) may be performed separately from the first heating step (S100), the stretching step (S200) may be performed during the heating step of the tube. Thus, the second heating step (S300) may be considered as a heating step on an extension line of the first heating step (S100). That is, if there is a necessity of cooling the glass tube after completion of the first heating step (S100) and the stretching step (S200), the second heating step (S300) is a completely separate step from the first heating step (S100). However, if there is no necessity, the second heating step (S300) may be performed as an extension of the first heating step (S100).

This method for sealing a fluorescent lamp may be performed after injecting a mixed gas containing inert gases such as mercury, argon, and neon into the glass tube. That is, prior to the first heating step (S100), one end of the glass tube is sealed, and then a process of exhausting gas in the glass tube through the other end of the glass tube, of which one end is sealed, and injecting the mixed gas thereinto is performed. Next, the other end of the glass tube is heated in the first heating step (S100), and the other heated end is stretched in the stretching step (S200). Subsequently, the other stretched end is heated in the second heating step (S300) until it is closed. As a result, it is possible to seal the glass tube in which the fluorescent material and mixed gas are filled.

Prior to the process of injecting the mixed gas into the glass tube, a process of exhausting gas in the tube and injecting a cleaning gas thereinto may be performed. Moreover, in order to reduce the heat impact according to the quality of the glass tube, each of the first heating step (S100) and the second heating step (S300) may be divided into a preheating step of heating the glass tube at a lower temperature and a heating step of heating the glass tube at a higher temperature.

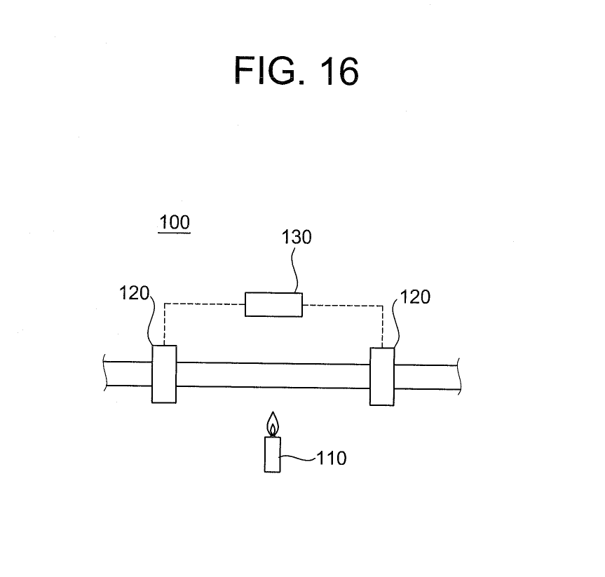

FIG. 16 shows an apparatus that may be used for sealing a fluorescent lamp in accordance with the foregoing embodiment. The apparatus includes a heat source 110, a supporting unit 120, and a driving device 130.

The heat source 110 heats a glass tube 21 to be melted and may comprise, for example, a torch. The inner wall of the tube is coated with a fluorescent material, and an inert gas including mercury may be already injected into the glass tube, if necessary. Moreover, it is preferable that the heat source is provided to move in the longitudinal direction of the tube so as to melt a wide range of the glass tube.

A pair of supporting units 120 provide support to respective sides of the glass tube and may be centered around the position of the heat source. To uniformly heat the tube, the pair of supporting units may movably support the glass tube.

The driving device 130 is provided to change the distance between the supporting units. For example, when a portion of the glass tube is melted by the heat source, the driving device increases the distance between the supporting units. As a result, the glass tube is stretched and thinned. When the thinned glass tube is continuously heated by the heat source, the glass is melted to close the tube and thereby complete the sealing process.

The apparatus of FIG. 16 may be modified to perform a variety of different or additional functions and/or to include other or additional components. For example, the apparatus of FIG. 16 may be used as a seal-cutting apparatus as well as a sealing apparatus. In other embodiments, the apparatus may be used to exhaust air in the glass tube and/or to inject a mixed gas thereinto, or a different type of seal-cutting apparatus may be provided.

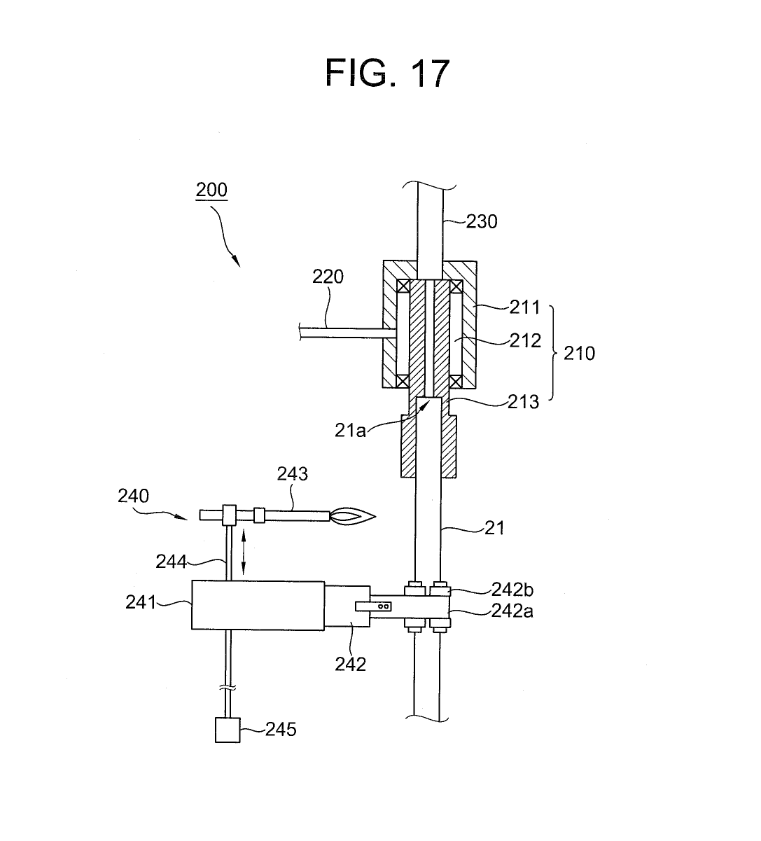

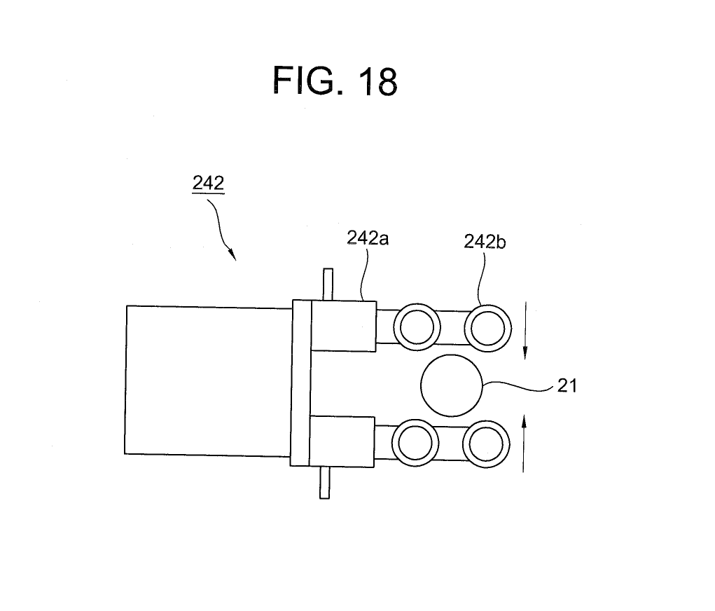

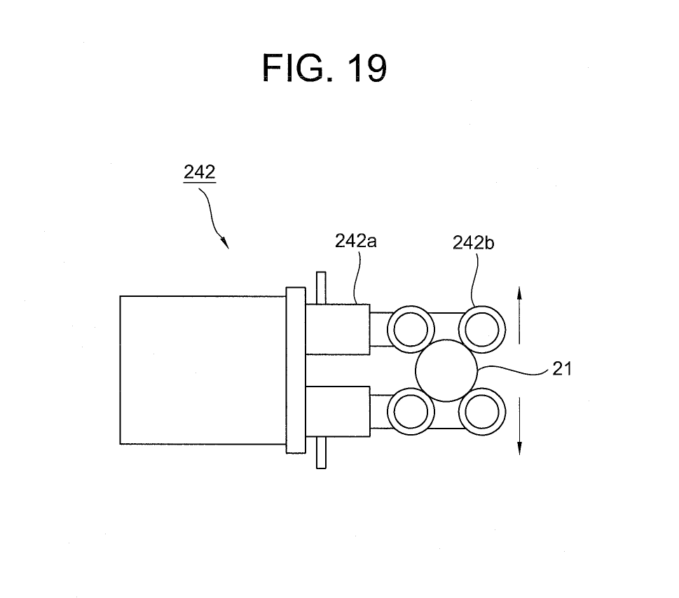

FIG. 17 shows another embodiment of an apparatus for sealing a fluorescent lamp, and FIGS. 18 and 19 show an auxiliary chuck that may be used with this apparatus. The apparatus of FIG. 17 includes a first sealing device for sealing a first end 21b of glass tube 21 and a second sealing device 200 for sealing a second end 21a of the glass tube. The first sealing device is substantially the same as the one shown in FIG. 5 or may be similar to portions of the second sealing device.

The second sealing device includes a mounting member 210 and a tip-off unit 240. The mounting member rotatably holds the second end 21a of the glass tube and corresponds to any one of the pair of supporting units 120 shown in FIG. 16. More specifically, the mounting member may include a housing 211 connected to an exhaust line 220 and a mercury injection line 230, a head 213 for holding the glass tube which is rotatably connected inside the housing, and joint 212 for rotatably connecting head 213 in the housing. A driving source may be used for rotating the head.

The joint 212 may be a well-known rotary joint. The exhaust line 220 is connected to an exhaust unit and an inert gas injection unit, and the mercury injection line 230 is connected to a mercury injection portion.

The tip-off unit 240 includes a body 241, a torch 243, and a chuck 242 for rotatably holding the glass tube. The torch may correspond to the heat source 110 in FIG. 16, and the chuck 242 may correspond to the other of the pair of supporting units 120 in FIG. 16. That is, the mounting member 210 and chuck 242 may correspond to supporting units 120 of FIG. 16.

The distance between the torch and body (chuck 242) may be adjusted by a lifting member 244. Accordingly, the heating point of the glass tube can be adjusted by valuing this distance. The lifting member may correspond to the device for driving the heat sources 110 in FIG. 16.

A driving unit 245 is provided for moving the body 241 up and down. With operation of the driving unit 245, the torch and chuck can be moved up and down together with the body. The driving unit may correspond to the driving device 130 in FIG. 16.

Referring to FIG. 18, in order to rotatably hold the glass tube, the chuck may include a pair of arms 242a, and a plurality of rollers 242b provided at ends of the arms and being in rolling contact with the glass tube. Each roller 242b may be an idle roller and, preferably, includes a friction member such as urethane provided on the surface thereof. Referring to FIG. 19, in operation, the pair of arms 242a are brought close to each other in order to hold the glass tube between the rollers 242b.

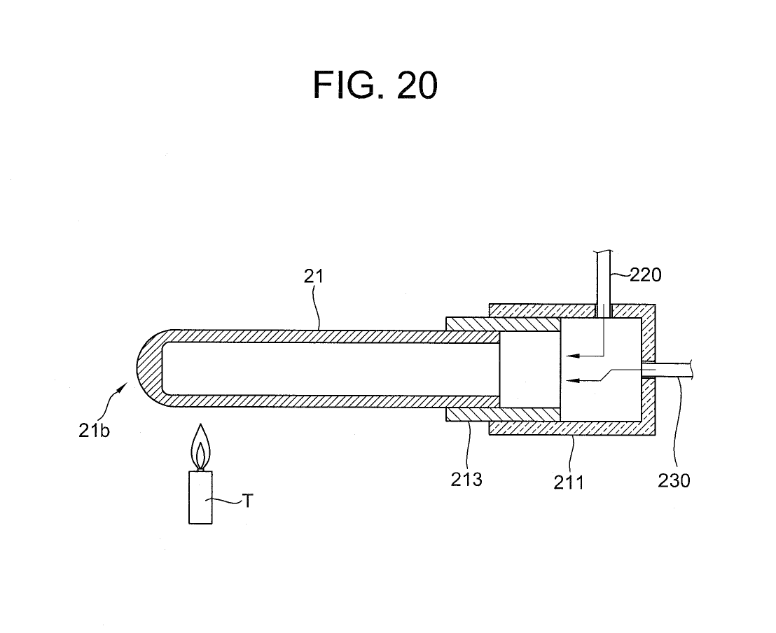

Operation of the apparatus for sealing a fluorescent lamp shown in FIGS. 17-19 will be described with reference to FIGS. 20 to 25. First, a process of coating and burning a fluorescent material on the inside of the glass tube 21 and a process of sealing the first end of the glass tube are performed. The processes may be the same as those shown in FIGS. 3 to 5.

Next, the glass tube having a sealed first end is mounted on the head 213 without performing the preliminary process shown in FIGS. 6 and 7. Then, a process of injecting and exhausting a cleaning gas and a process of injecting an inert gas and liquid mercury are performed (see FIG. 20). Since no temporary sealing region or fine tube is performed, the liquid mercury is not smeared on the inner wall of the tube and thus it is possible to supply a sufficient quantity of the mercury.

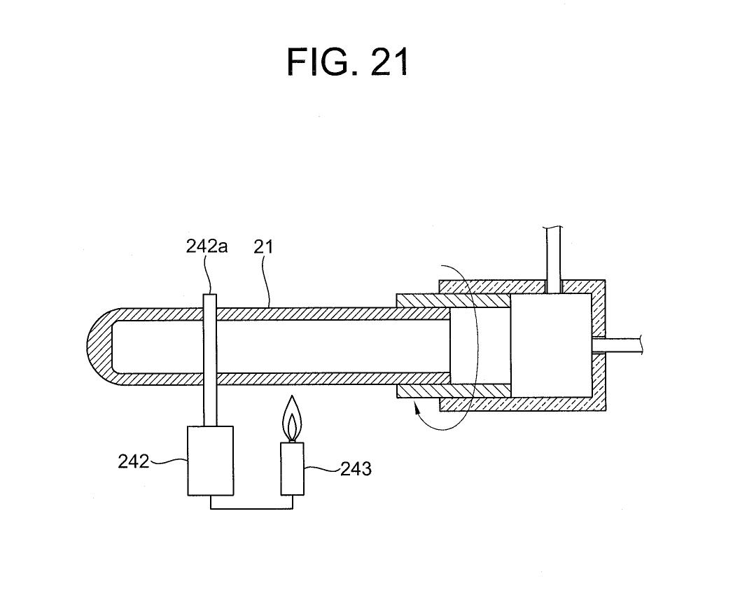

Meanwhile, since the head is rotatably provided in housing 211 connected to the exhaust line 220 and the mercury injection line 230, the glass tube can be rotated by rotating head 213. While the glass tube is rotated the sealing region is heated by the torch 243. At this time, chuck 242 holds the lower portion (FIG. 21) of the glass tube. The chuck is provided so that it does not interfere with rotation of the glass tube.

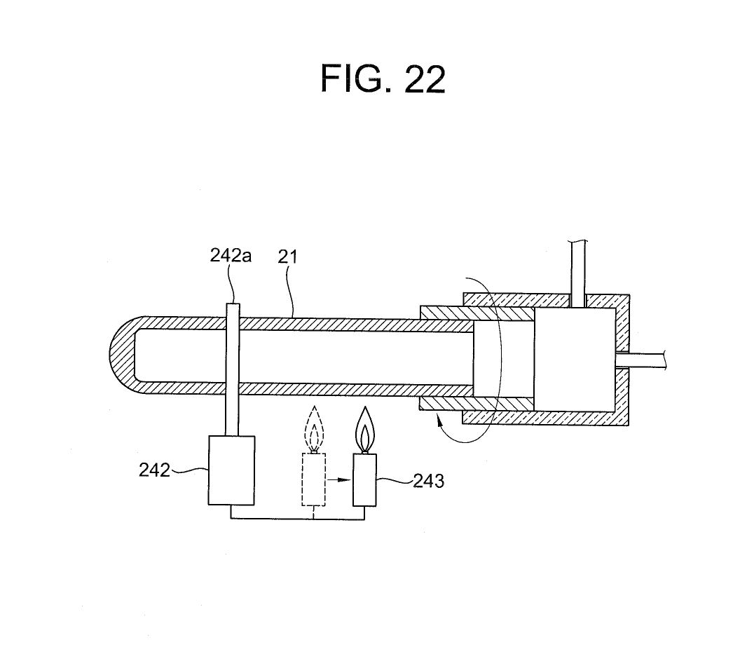

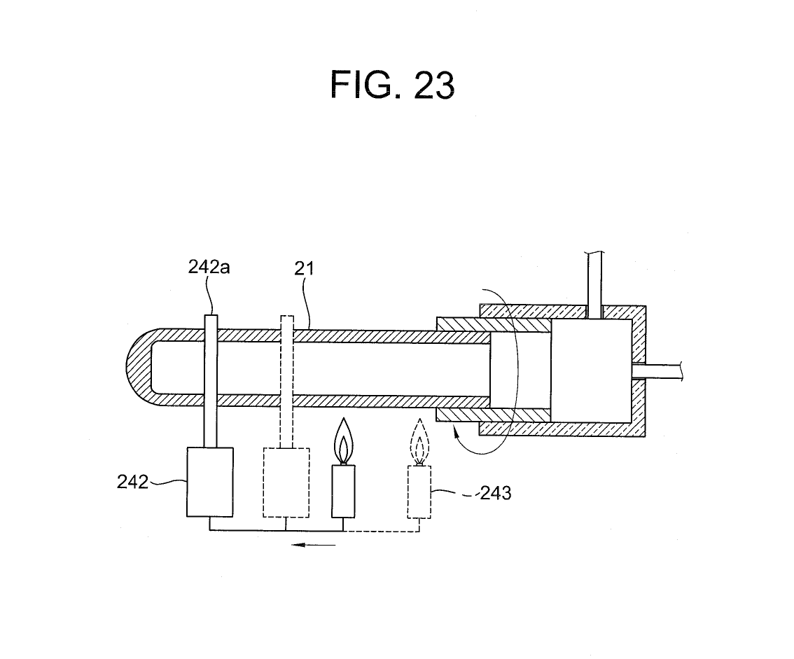

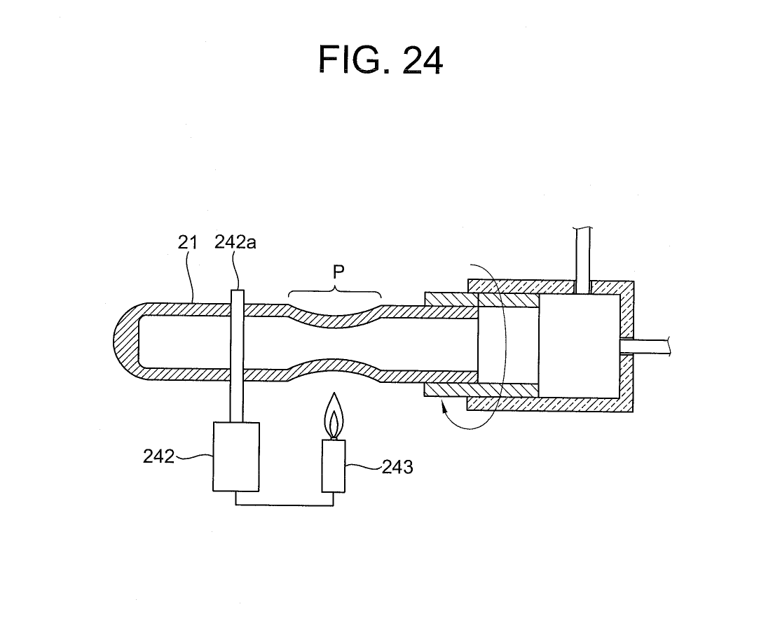

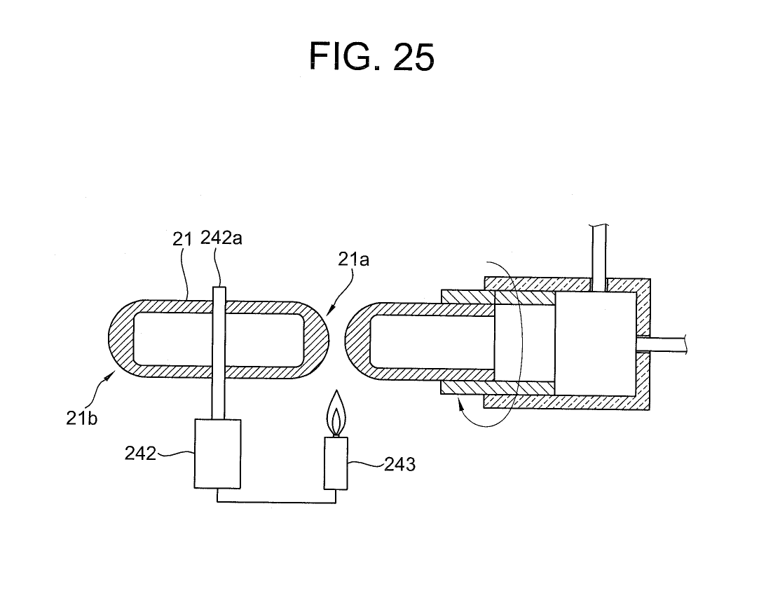

When the sealing region is heated to a semi-melted state, the torch is moved slightly toward the second end (FIG. 22) while the chuck is left at its position. Next, the chuck 242 and the torch 243 of the tip-off unit 240 are moved down (See FIG. 23) using the driving unit (not shown), and the sealing region of the glass tube in a semi-melted state is stretched and thinned as a result (FIG. 24). By continuously heating the sealing region using the torch, the second end 21a of the glass tube is sealed as shown in FIG. 25.

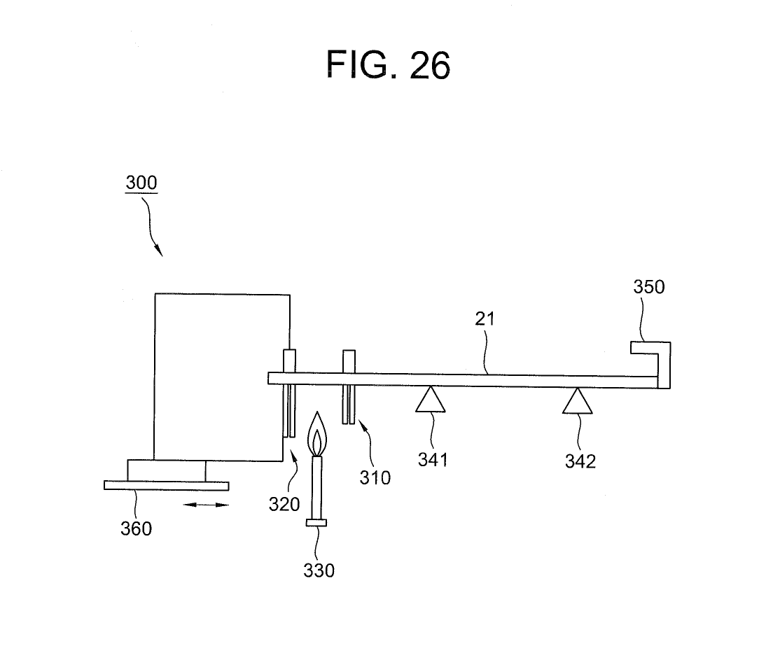

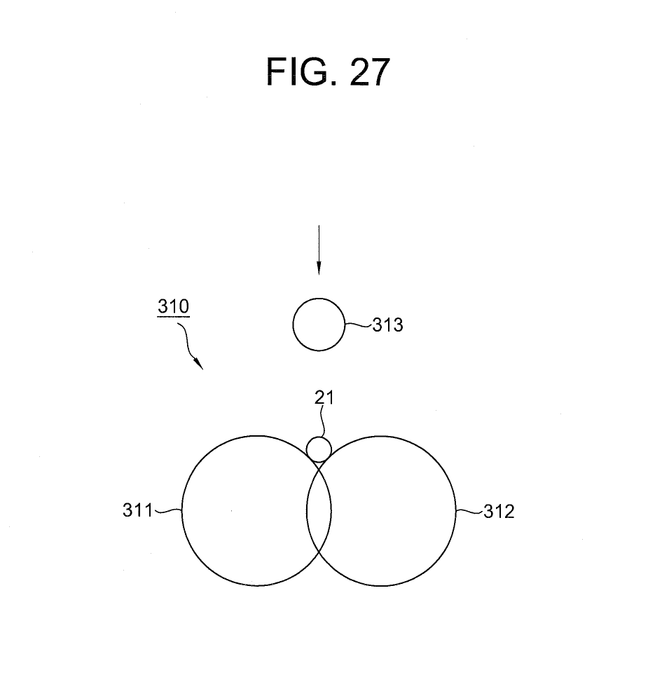

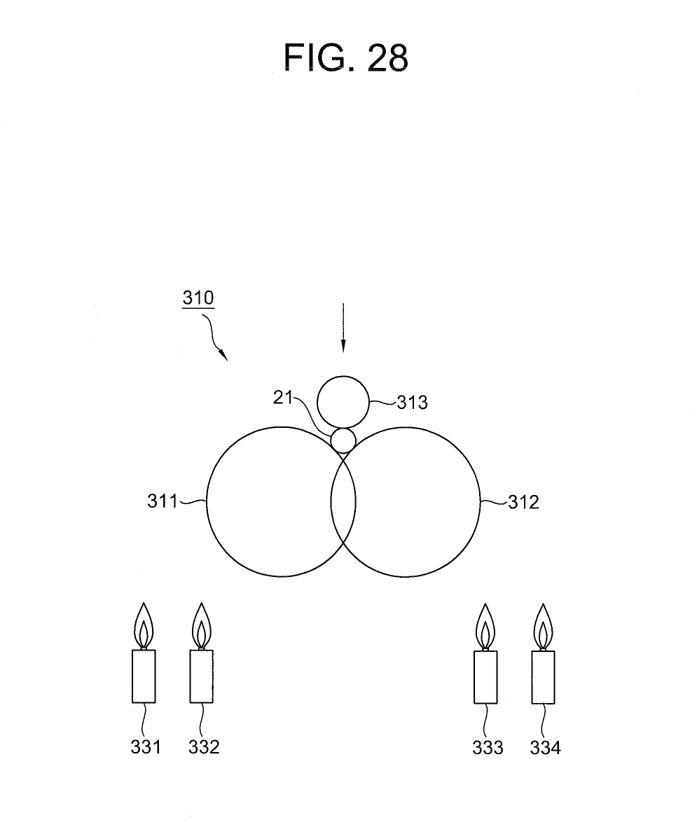

FIG. 26 shows a third embodiment of an apparatus 300 for sealing a fluorescent lamp, and FIGS. 27 and 28 are show part of this apparatus. The apparatus (which also may be referred to as a seal-cutting apparatus) includes a fixed roller portion 310, a variable roller portion 320, a heater 330, and a movable member 360. The fixed roller portion supports and rotates the glass tube 21, and the variable roller portion 320 supports and rotates the glass tube and, at the same time, stretches the glass tube in a semi-melted state. The fixed roller portion and the variable roller portion may be considered to correspond to the supporting units 120 in FIG. 16.

The heater is disposed between the fixed roller portion 310 and the variable roller portion 320 to heat, seal, and seal-cut the glass tube. The heater may be considered to correspond to the heat source 110 in FIG. 16.

The movable member 360 horizontally moves the variable roller portion 320 in the longitudinal direction of the glass tube, so that the variable roller portion stretches the glass tube. The movable member may be considered to correspond to the driving device 130 in FIG. 16. Supporting members 341 and 342 may be provided for supporting the glass tube at an opposite side of the variable roller portion and the fixed roller portion.

Moreover, a gauge 350 for regulating the length of the glass tube in accordance with a predetermined length of the fluorescent lamp to be fabricated is provided. The gauge may be moved to correspond to changes in the length of the lamp or to accommodate different kinds of tubes having different lengths.

Referring to FIG. 27, the fixed roller portion 310 includes a pair of driving rollers 311 and 312 for upwardly supporting glass tube 21 while rotating. An idle roller 313 may be included for downwardly pressing the glass tube received in a region where the driving rollers overlap each other. It is preferable that the driving rollers and the idle roller include a friction member such as urethane provided on the surfaces thereof. The variable roller portion 320 may be formed the same as the fixed roller portion 310.

Referring to FIG. 28, when the idle roller 313 is moved downward to press the glass tube, the tube is rotated by rotation of driving rollers 311 and 312. Moreover, a plurality of torches 331 to 334 may be provided at the bottom of the glass tube supported by the fixed roller portion 310. The torches may be used to seal the first end of the glass tube, and torches 333 and 334 may be used as cutting torches during seal-cutting of the second end of the glass tube.

Moreover, the first and third torches may be used as preheating torches and the second and fourth torches 332 and 334 may be used as the heating torches. The second and fourth torches may apply a greater amount of heat than the first and third torches. A transfer device for loading or unloading the first to fourth torches 331 to 334 at the bottom of the glass tube 21 may be provided as necessary.

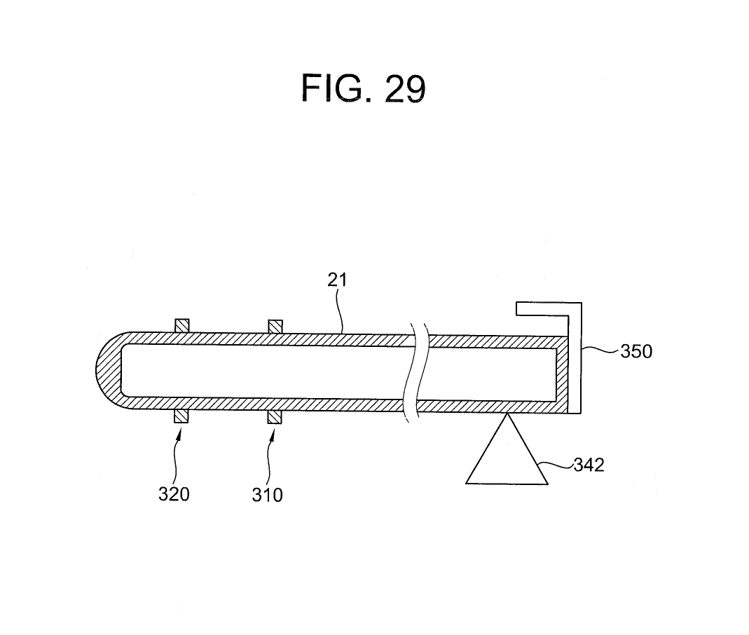

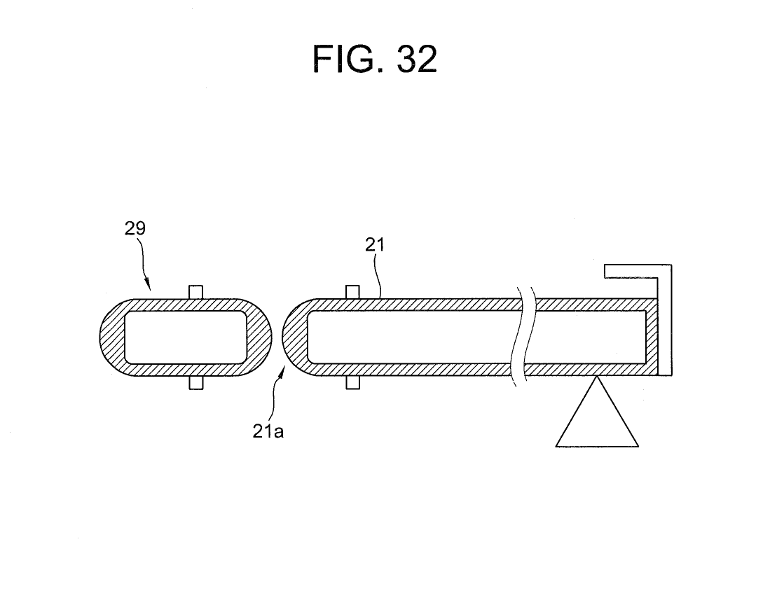

Operation of the apparatus of FIG. 26 for sealing a fluorescent lamp will be described with reference to FIGS. 29 to 32. First, a glass tube 21 having sealed ends is received on the fixed roller portion 310, variable roller portion 320, and the supporting member 342, and fixed thereto (FIG. 29). At this time, the position of the glass tube is regulated by gauge 350 which is adjusted in advance according to the length of the fluorescent lamp.

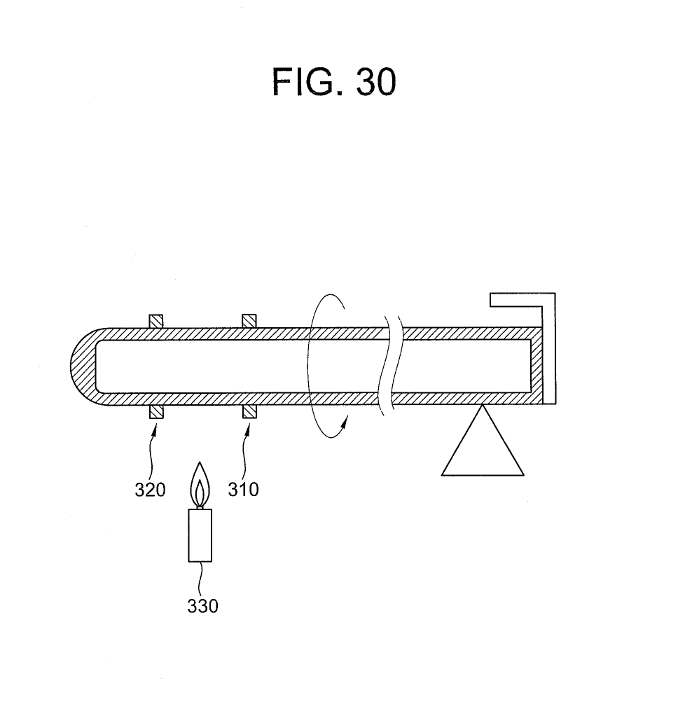

Next, the glass tube is rotated by the rotation of the driving rollers of fixed roller portion 310 and variable roller portion 320 and heated by heater 330. The heater is disposed between the fixed roller portion and variable roller portion to heat the glass tube (FIG. 30). At this time, the preheating torch preheats the glass tube and then the heating torch heats the glass tube to some predetermined degree.

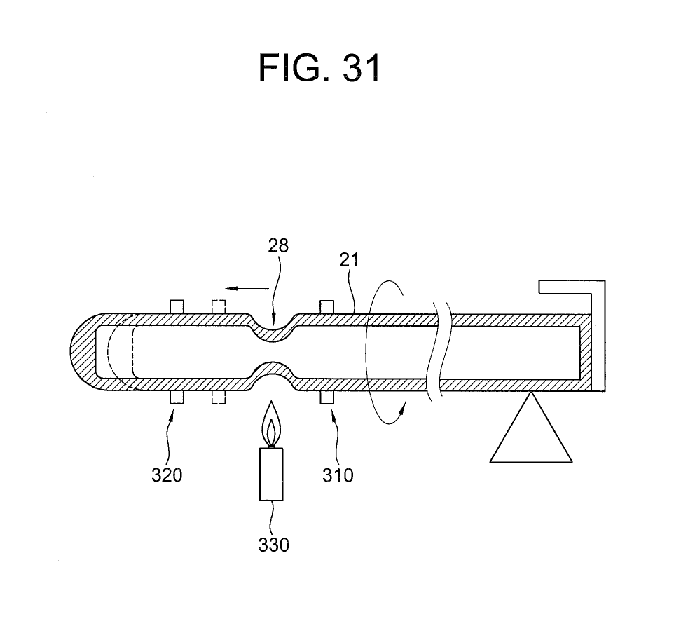

When the heated region 28 of the glass tube is in a semi-melted state, the fixed roller portion is left in its position, and the variable roller portion holds the glass tube and moves in the horizontal direction so as to stretch the glass tube. When the variable roller portion is moved horizontally, heated region 28 of the glass tube in a semi-melted state is thinned and stretched (FIG. 31).

Even in this state, the glass tube is continuously rotated and, if heat is continuously applied thereto, an unnecessary region 29 is removed and, at the same time, a desired shape of the second end 21a is formed.

Seal-cutting apparatus 300 can perform the sealing process of the first end of the glass tube in addition to the seal-cutting process if desired. When used in this manner, the glass tube in which a fluorescent material is coated and heated is supported and fixed by fixed roller portion 310, variable roller portion 320, and supporting members 341 and 342. In this state, the driving rollers of the fixed roller portion and the variable roller portion are rotated to rotate the glass tube.

Next, first torch 331 is loaded at the bottom of the first end of the glass tube by a transfer device to preheat the glass tube. When the glass tube is preheated to some predetermined degree, the first torch is unloaded and second torch 332 is loaded to heat the glass tube, thereby completing the sealing process of the first end of the glass tube.

One or more embodiments described herein, therefore, provide a method and apparatus for sealing a fluorescent lamp, in which after a first end of the fluorescent lamp is sealed, a second end of the fluorescent lamp can be directly sealed without any preliminary process such as a temporary sealing process or a process of adhering a fine tube. These embodiments may also seal a first end of a glass tube, seal a second end, and perform a seal-cutting process all using the same equipment and without transferring the glass tube to separately processing locations.

In accordance one embodiment, a method for sealing a fluorescent lamp comprises heating a portion of a glass tube in which a fluorescent material is coated (first heating step); stretching the glass tube centered around the heated region; and heating the stretched region of the glass tube (second heating step). This method may further include sealing an end of the glass tube prior to the first heating step, and exhausting gas in the glass tube and injecting a mixed gas thereinto through the other end of the glass tube of which one end is sealed, and in the first heating step, the other end of the glass tube may be heated.

In the step of injecting the mixed gas, a cleaning gas may be injected into the glass tube before injecting the mixed gas after discharging air in the glass tube. At least one of the first and second heating steps may be performed while rotating the glass tube. At least one of the first and second heating steps may include, preheating a portion of the glass tube to a predetermined temperature, and heating the preheated portion of the glass tube to a temperature higher than the predetermined temperature. In the first heating step, a heat source may be moved in the longitudinal direction of the glass tube.

In accordance with another embodiment, an apparatus for sealing a fluorescent lamp comprises a heat source for heating a glass tube in which a fluorescent material is coated; a pair of supporting units provided at both sides of the heat source to support the glass tube; and a driving unit for changing a distance between the pair of supporting units. The supporting units may rotatably support the glass tube. The heat source may be provided to move in the longitudinal direction of the glass tube.

In accordance with another embodiment, an apparatus for sealing a fluorescent lamp comprises a mounting member for rotatably supporting a glass tube in which a fluorescent material is coated; an exhaust unit for exhausting gas in the glass tube through one end of the glass tube; a gas injection unit for injecting a gas into the glass tube through the end of the glass tube; and a tip-off unit for heating and sealing the end of the glass tube. The mounting member may include a housing, a head for holding the glass tube, a joint for rotatably connecting the head in the housing, and a driving source for rotating the head.

The apparatus for sealing a fluorescent lamp may further include an exhaust line and a gas injection line connected to the housing. The tip-off unit may include a torch for heating the glass tube, and a chuck for rotatably holding the glass. The chuck may include a roller being in rolling contact with the glass tube. The apparatus for sealing a fluorescent lamp may further include a friction member provided on the surface of the roller. The torch may be provided to move in the longitudinal direction of the glass tube, separately from the chuck. The apparatus for sealing a fluorescent lamp may further include a driving unit for moving the tip-off unit in the longitudinal direction of the glass tube.

In accordance with another embodiment, an apparatus for sealing a fluorescent lamp comprises a fixed roller portion for supporting and rotating a glass tube in which a fluorescent material is coated; a variable roller portion spaced from the fixed roller portion and supporting and rotating the glass tube; a heating means for heating the glass tube; and a movable member for horizontally moving the variable roller portion holding the glass tube in the longitudinal direction of the glass tube so as to stretch the glass tube in a semi-melted state.

The fixed roller portion may include a pair of driving rollers for supporting and rotating the glass tube, and an idle roller for downwardly pressing the glass tube. The variable roller portion may include a pair of driving rollers for supporting and rotating the glass tube, and an idle roller for downwardly pressing the glass tube.

The apparatus for sealing a fluorescent lamp may further include a friction member provided on the surface of the driving rollers or the idle roller. The friction member may be formed of a urethane material. The heating means may include at least one torch. The heating means may include a sealing torch and a seal-cutting torch. The sealing torch may include a first torch for preheating a sealing region of the glass tube, and a second torch for heating the preheated sealing region to seal a first end of the glass tube.

The seal-cutting torch may include a third torch for preheating a sealing region of the glass tube, and a fourth torch for heating the preheated sealing region to seal a second end of the glass tube.

The apparatus for sealing a fluorescent lamp may further include a transfer means for loading or unloading the torch at the bottom of the glass tube. The apparatus for sealing a fluorescent lamp may further include a gauge for regulating the loading position of the glass tube.

The foregoing embodiments may therefore be applied to reduce process time by eliminating one or more preliminary processes, such as the temporary sealing process or the process of adhering the fine tube, before sealing the second end of the fluorescent lamp after the first end has been sealed. As a result, the apparatus is simplified. Moreover, with automation of the second end sealing process, it is possible to ensure the identity of the products and prevent the safety accidents using the embodiments disclosed herein.

Furthermore, it is possible to prevent the liquid mercury form being smeared on the temporary sealing region. In addition, the sealing process of the first end of the glass tube and the process of seal-cutting of the second end thereof can be performed using the same equipment, and the seal-cutting process can be performed without transfer of the glass tube. Accordingly, the apparatus is simplified, the process time is reduced, and it is possible to prevent the glass tube from being broken.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments of the present invention have been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

What is claimed is:

1. A method for sealing a fluorescent lamp, comprising:
performing a first heating operation to heat a region of a glass tube in which a fluorescent material is coated;
stretching the glass tube at the heated region; and
performing a second heating operation to heat the stretched region of the glass tube.

2. The method of claim 1, further comprising:
sealing a first end of the glass tube prior to the first heating operation; and
exhausting gas and injecting a mixed gas into the glass tube through a second end of the glass tube, wherein the first heating operation heats the second end of the glass tube.

3. The method of claim 1, wherein injecting the mixed gas includes injecting a cleaning gas into the glass tube before injecting the mixed gas after discharging air in the glass tube.

4. The method of claim 1, wherein at least one of the first or second heating operations is performed while the glass tube is rotated.

5. The method of claim 1, wherein at least one of the first or second heating operations comprises:
preheating the glass tube to a predetermined temperature; and
heating the preheated glass tube to a temperature higher than the predetermined temperature.

6. The method of claim 1, wherein the first heating operation includes moving a heat source in a longitudinal direction of the glass tube.

7. An apparatus for sealing a fluorescent lamp, comprising:
a mounting member for rotatably supporting a glass tube in which a fluorescent material is coated;
an exhaust unit for exhausting gas through a first end of the glass tube;
a gas injection unit for injecting a gas through the first end of the glass tube; and
a tip-off unit for heating and sealing a second end of the glass tube.

8. The apparatus of claim 7, wherein the mounting member comprises:
a housing;
a head for holding the glass tube;
a joint for rotatably connecting the head in the housing; and
a driving source for rotating the head.

9. The apparatus of claim 8, further comprising:
an exhaust line and a gas injection line connected to the housing.

10. The apparatus of claim 7, wherein the tip-off unit comprises:
a torch for heating the glass tube; and
a chuck for rotatably holding the glass.

11. The apparatus of claim 10, wherein the chuck comprises a roller in rolling contact with the glass tube.

12. The apparatus of claim 11, further comprising:
a friction member on the surface of the roller.

13. The apparatus of claim 10, wherein the torch is provided to move in the longitudinal direction of the glass tube, separately from the chuck.

14. The apparatus of claim 10, further comprising:
a driving unit for moving the tip-off unit in the longitudinal direction of the glass tube.

15. An apparatus for sealing a fluorescent lamp, comprising:
a fixed roller portion for supporting and rotating a glass tube in which a fluorescent material is coated;
a variable roller portion, spaced from the fixed roller portion for supporting and rotating the glass tube;
a heater for heating the glass tube; and
a movable member for horizontally moving the variable roller portion holding the glass tube in a longitudinal direction of the glass tube so as to stretch the glass tube in a semi-melted state.

16. The apparatus of claim 15, wherein the fixed roller portion comprises:
a pair of driving rollers for supporting and rotating the glass tube; and
an idle roller for downwardly pressing the glass tube.

17. The apparatus of claim 15, wherein the variable roller portion comprises:
a pair of driving rollers for supporting and rotating the glass tube; and
an idle roller for downwardly pressing the glass tube.

18. The apparatus of claim 16, further comprising:
a friction member on the surface of the driving rollers or the idle roller.

19. The apparatus of claim 15, wherein the heating means comprises a sealing torch and a seal-cutting torch.

20. The apparatus of claim 19, wherein the sealing torch comprises:
a first torch for preheating a sealing region of the glass tube; and
a second torch for heating the preheated sealing region to seal a first end of the glass tube, and wherein the seal-cutting torch comprises:
a third torch for preheating a sealing region of the glass tube; and
a fourth torch for heating the preheated sealing region to seal a second end of the glass tube.
